(19) United States
(12) Patent Application Publication
(10) Pub. No.: US 2026/0280160 A1
(43) Pub. Date: Sep. 17, 2026

(54) TERMINAL BLOCK AND WIRING HARNESS

(71) Applicant: SUMITOMO WIRING SYSTEMS, LTD., Mie (JP)

(72) Inventors: Kota ONODERA, Mie (JP); Takuya ISHIKAWA, Mie (JP)

(21) Appl. No.: 19/470,819

(22) PCT Filed: Apr. 3, 2024
(86) PCT No.: PCT/JP2024/013753

§ 371 Date: Sep. 30, 2025

(30) Foreign Application Priority Data
Apr. 3, 2023 (JP) 2023-060217

(51) Int. Cl. H01R 9/24; H01B 7/00; H01R 4/38; H01R 9/18

(52) U.S. Cl. CPC H01R 9/2416; H01B 7/0045; H01R 4/38; H01R 9/18

(57) ABSTRACT

A terminal block (10) is provided with: a first connection part (31) and a second connection part (32) to which a first terminal (11) and a second terminal (12) are connected, respectively; a bus bar (33) that electrically connects the first connection part (31) and the second connection part (32) to each other; and a housing (30) that houses the first connection part (31), the second connection part (32), and the bus bar (33). The housing (30) has a first path regulation section (R1) that regulates the path of a first electric wire (13), and a second path regulation section (R2) that regulates the path of a second electric wire (14).

### TECHNICAL FIELD

The present disclosure relates to a terminal block and a wiring harness.

### BACKGROUND

For example, a terminal block described in Patent Document 1 is provided with a plurality of connecting portions and a busbar for electrically connecting the plurality of connecting portions to each other. A plurality of terminals of a plurality of wires are respectively connected to the plurality of connecting portions. In this way, the plurality of wires are electrically connected via the busbar.

### PRIOR ART DOCUMENT

### Patent Document

Patent Document 1: JP 2022-007709 A

### SUMMARY OF THE INVENTION

### Problems to be Solved

The present inventor and other researchers studied how to suppress the vibration of wires connected to connecting portions of a terminal block in the terminal block as described above.

The present disclosure aims to provide a terminal block and a wiring harness capable of suppressing the vibration of wires.

### Means to Solve the Problem

The present disclosure is directed to a terminal block with a plurality of connecting portions to be respectively connected to a plurality of terminals of a plurality of wires, a busbar for electrically connecting the plurality of connecting portions, and a housing for accommodating the plurality of connecting portions and the busbar, the housing including a path restricting portion for restricting a path of at least one of the plurality of wires.

### Effect of the Invention

According to the terminal block and a wiring harness of the present disclosure, it is possible to suppress the vibration of wires connected to a terminal block.

### BRIEF DESCRIPTION OF THE DRAWINGS

FIG. 1 is a perspective view of a wiring harness in an embodiment.

FIG. 2 is an exploded perspective view of the wiring harness in the embodiment.

FIG. 3 is a front view of the wiring harness in the embodiment.

FIG. 4 is a section along 4-4 in FIG. 3.

FIG. 5 is an exploded perspective view of a housing body in the embodiment.

### DETAILED DESCRIPTION TO EXECUTE THE INVENTION

### Description of Embodiments of Present Disclosure

First, embodiments of the present disclosure are listed and described.

[1] The terminal block of the present disclosure is provided with a plurality of connecting portions to be respectively connected to a plurality of terminals of a plurality of wires, a busbar for electrically connecting the plurality of connecting portions, and a housing for accommodating the plurality of connecting portions and the busbar, the housing including a path restricting portion for restricting a path of at least one of the plurality of wires.

According to this configuration, at least one of the plurality of wires can be stably held by the path restricting portion of the housing. As a result, the vibration of this wire can be suppressed.

[2] In [1] described above, the plurality of terminals may be respectively fastened and fixed to the plurality of connecting portions, and the plurality of connecting portions may be so configured that fixing directions of the plurality of terminals to the plurality of connecting portions are the same direction.

According to this configuration, the respective terminals can be fastened and fixed to the respective connecting portions of the terminal block from the same direction. Thus, workability in mounting the respective terminals to the respective connecting portions of the terminal block can be improved.

[3] In [2] described above, the plurality of terminals may include a first terminal and a second terminal, the housing may include a first arrangement portion where the first terminal is arranged and a second arrangement portion where the second terminal is arranged, and the first and second arrangement portions may at least partially overlap in the fixing direction.

According to this configuration, since the first and second arrangement portions at least partially overlap when viewed from the fixing direction of the terminals and the connecting portions of the terminal block, the terminal block can be reduced in size in a direction orthogonal to the fixing direction.

[4] In [3] described above, the plurality of connecting portions may include a first connecting portion to be connected to the first terminal and a second connecting portion to be connected to the second terminal, the first and second connecting portions may be provided at positions shifted from each other in the fixing direction, and the second connecting portion may be located in front of the first connecting portion if the fixing direction of the terminals to the connecting portions is a forward direction.

According to this configuration, the first arrangement portion where the first terminal is arranged and the second arrangement portion where the second terminal is arranged can be overlapped by arranging the second connecting portion in front of the first connecting portion in the fixing direction. As a result, it can contribute to the size reduction of the terminal block in the direction orthogonal to the fixing direction.

[5] In [4] described above, the housing may include a housing body for holding the first and second connecting portions and a separate component to be assembled with the housing body, the separate component may be located between the first and second arrangement portions in the fixing direction, and the path restricting portion may be at least partially provided in the separate component.

According to this configuration, the interference of the wires respectively connected to the first and second terminals can be suppressed by the separate component arranged between the first and second arrangement portions. Further, the path of the wire can be suitably restricted by the path restricting portion by providing at least a part of the path restricting portion in the separate component.

[6] In [5] described above, the plurality of wires may include a first wire provided with the first terminal and a second wire provided with the second terminal, the path restricting portions may include a first path restricting portion for restricting a path of the first wire and a second path restricting portion for restricting a path of the second wire, and the first and second path restricting portions may be at least partially provided in the separate component.

According to this configuration, the paths of the first and second wires can be respectively restricted by the first and second path restricting portions at least partially provided in the separate component.

[7] In any one of [4] to [6] described above, the first connecting portion may include a first bolt held in the housing and a first nut to be mounted to the first bolt, the first terminal may be fastened by the first bolt and the first nut, the second connecting portion may include a second nut held in the housing and a second bolt to be mounted to the second nut, and the second terminal may be fastened by the second nut and the second bolt.

According to this configuration, at the time of mounting the first terminal, the first terminal can be temporarily held by being hooked to the first bolt held in the housing. In this way, workability in mounting the first terminal can be improved. Since not a bolt, but the second nut is held in the housing in the second connecting portion, the interference of the second connecting portion with the first wire and the first terminal can be prevented.

[8] In any one of [4] to [7] described above, the plurality of wires may be pulled out in a height direction of the terminal block when viewed from the fixing direction, and the first and second connecting portions may be provided at positions shifted from each other in the height direction.

According to this configuration, the terminal block can be reduced in size in a width direction orthogonal to the height direction.

[9] A wiring harness of the present disclosure is provided with the terminal block of any one of [1] to [8] described above, a plurality of terminals to be mounted into the terminal block, and a plurality of wires respectively provided with the plurality of terminals.

According to this configuration, functions and effects similar to the above terminal block can be achieved.

### Details of Embodiment of Present Disclosure

Specific examples of a terminal block and a wiring harness of the present disclosure are described below with reference to the drawings. For the convenience of description, some components may be shown in an exaggerated or simplified manner in each drawing. Further, a dimension ratio of each part may be different in each drawing. Further, “parallel” and “orthogonal” in this specification mean not only strictly parallel and orthogonal, but also substantially parallel and orthogonal within a range in which functions and effects in an embodiment are achieved.

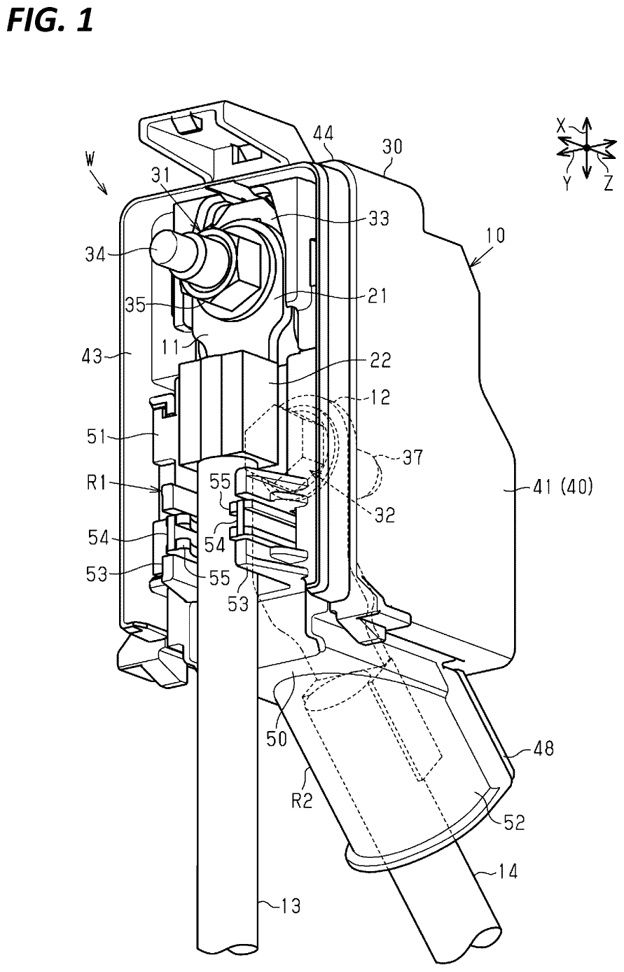

As shown in FIG. 1, a wiring harness W of this embodiment is provided with a terminal block 10, a first terminal 11 and a second terminal 12 to be mounted into the terminal block 10 and a first wire 13 and a second wire 14 respectively connected to the first and second terminals 11, 12. Note that, in each figure, X, Y and Z directions orthogonal to each other are shown and respectively referred to as a height direction X, a width direction Y and a depth direction Z.

The wiring harness W is, for example, used in a vehicle. The wiring harness W is, for example, a wiring harness for high voltage in which a conductor cross-sectional area of each of the first and second wires 13, 14 is set to be approximately equal to or more than 10 mm². The wiring harness W is, for example, arranged near an engine unit in an engine compartment of the vehicle. The terminal block 10 is, for example, arranged to face the engine unit in the width direction Y.

### (First Terminal 11 and Second Terminal 12)

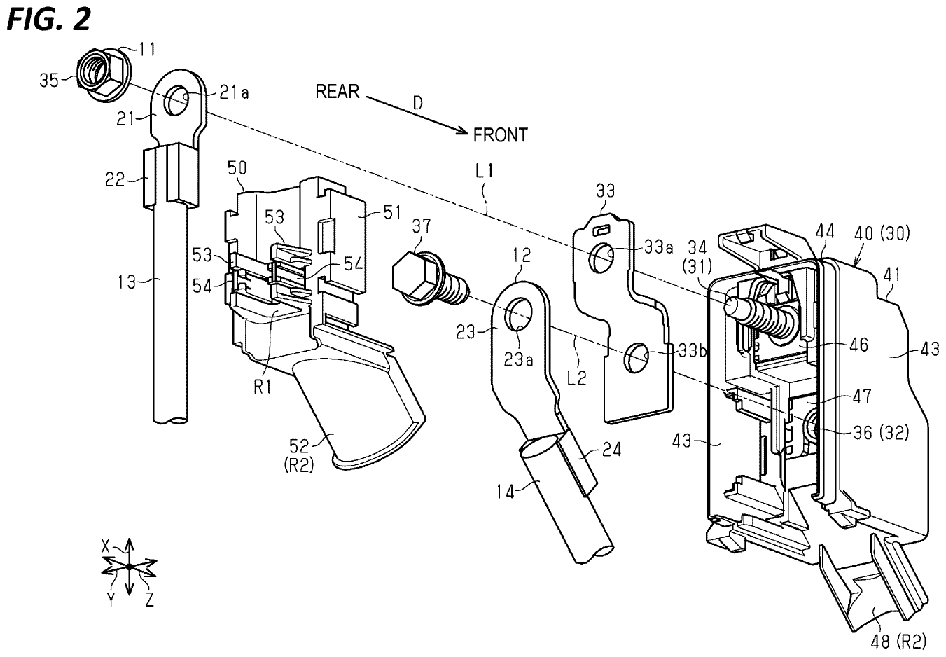

As shown in FIG. 2, each of the first and second terminals 11, 12 is, for example, formed by press-working a metal plate material. The first terminal 11 is connected to one end part in a length direction of the first wire 13. The first terminal 11 includes a fastening portion 21 to be fastened and fixed to a first connecting portion 31 of the terminal block and a wire connecting portion 22 to be connected to the first wire 13. The fastening portion 21 is formed with a through hole 21a penetrating through the fastening portion 21 in a plate thickness direction.

The second terminal 12 is connected to one end part in a length direction of the second wire 14. The second terminal 12 includes a fastening portion 23 to be fastened and fixed to a second connecting portion 32 of the terminal block 10 and a wire connecting portion 24 to be connected to the second wire 14. The fastening portion 23 is formed with a through hole 23a penetrating through the fastening portion 23 in a plate thickness direction. The wire connecting portions 22, 24 of the first and second terminals 11, 12 are respectively connected to the first and second wires 13, 14, for example, by crimping.

Each of the first and second wires 13, 14 includes an unillustrated core wire and an insulation coating covering the outer periphery of the core wire. The respective core wires of the first and second wires 13, 14 are electrically connected to the respective wire connecting portions 22, 24 of the first and second terminals 11, 12. The respective first and second wires 13, 14 are pulled out to the outside of the terminal block 10 from one side (lower side in this embodiment) in the height direction X of the terminal block 10.

### (Terminal Block 10)

As shown in FIG. 1, the terminal block 10 is provided with a housing 30, the first and second connecting portions 31, 32 and a busbar 33. Each of the first and second connecting portions 31, 32 and the busbar 33 is accommodated in the housing 30. The first and second terminals 11, 12 are respectively fastened and fixed to the first and second connecting portions 31, 32.

### (First Connecting Portion 31 and Second Connecting Portion 32)

The first connecting portion 31 includes a first bolt 34 held in the housing 30 and a first nut 35 to be mounted to the first bolt 34. The fastening portion 21 of the first terminal 11 is fastened and fixed together with the busbar 33 by the first bolt 34 and the first nut 35.

The second connecting portion 32 includes a second nut 36 held in the housing 30 and a second bolt 37 to be mounted to the second nut 36. The fastening portion 23 of the second terminal 12 is fastened and fixed together with the busbar 33 by the second nut 36 and the second bolt 37.

As shown in FIG. 2, the first and second connecting portions 31, 32 are so configured that fastening directions thereof are the same direction. In particular, the first bolt 34 of the first connecting portion 31 and the second nut 36 of the second connecting portion 32 are respectively so held in the housing 30 that axes L1, L2 thereof are parallel to each other. That is, a mounting direction of the first nut 35 to the first bolt 34 and that of the second bolt 37 to the second nut 36 are the same direction. Note that the mounting direction of each of the first nut 35 and the second bolt 37 is, for example, along the depth direction Z of the terminal block 10. The axis L1 of the first bolt 34 and the axis L2 of the second nut 36 are, for example, arranged along the height direction X of the terminal block 10.

The busbar 33 is, for example, formed by press-working a metal plate material. The busbar 33 includes a first through hole 33a, into which the first bolt 34 is inserted, and a second through hole 33b, into which the second bolt 37 is inserted. The busbar 33 is electrically connected to the first terminal 11 by fastening the first bolt 34 and the first nut 35. Further, the busbar 33 is electrically connected to the second terminal 12 by fastening the second bolt 37 and the second nut 36. In this way, the busbar 33 electrically connects the first and second connecting portions 31, 32 to each other.

### (Housing 30)

The housing 30 includes a housing body 40 for holding the first and second connecting portions 31, 32 and a separate component 50 to be assembled with the housing body 40.

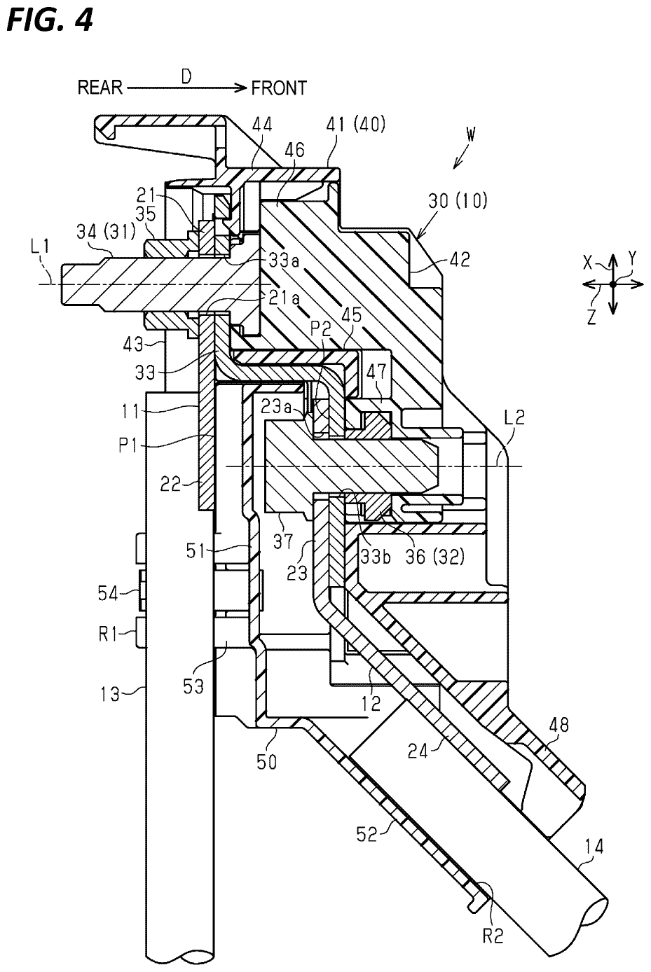

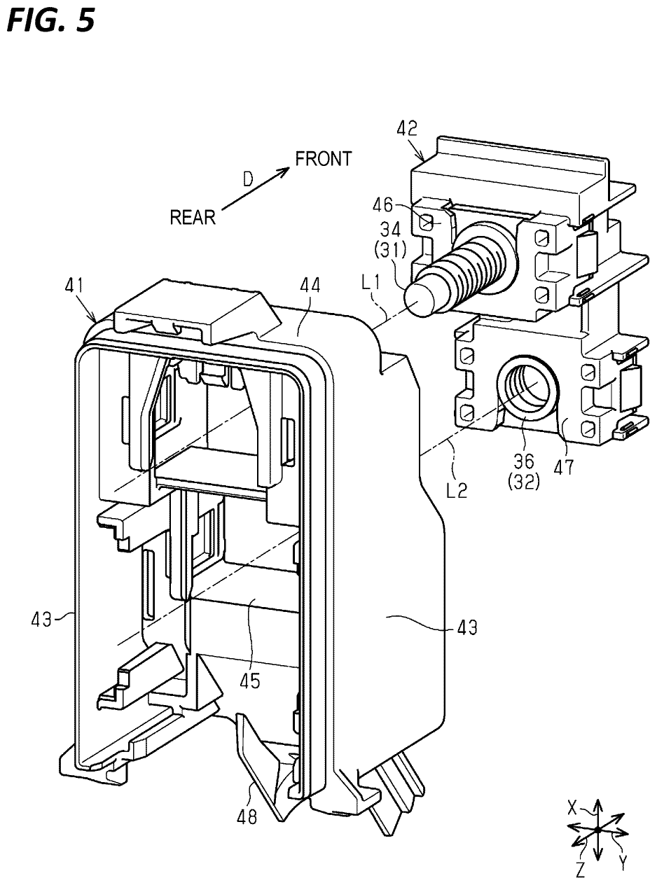

As shown in FIGS. 4 and 5, the housing body 40 is, for example, provided with a frame body 41 and a holding component 42 to be assembled inside the frame body 41.

The frame body 41 has, for example, a substantially rectangular shape longer in the height direction X than in the width direction Y when viewed from a fastening direction D. The frame body 41 forms the outer contour of the housing 30. That is, the housing 30 has, for example, a substantially rectangular shape longer in the height direction X than in the width direction Y when viewed from the fastening direction D.

The frame body 41 is, for example, provided with a pair of side walls 43 orthogonal to the width direction Y and an upper wall 44 connecting upper end parts of the pair of side walls 43. The frame body 41 includes a mounting portion 45, into which the holding component 42 is mounted, in an inner part surrounded by the pair of side walls 43 and the upper wall 44. The frame body 41 is, for example, mounted on an unillustrated mounting part provided in the engine compartment of the vehicle.

The holding component 42 is, for example, detachably mountable into the mounting portion 45. The holding component 42 includes a first holding portion 46 for holding the first bolt 34 and a second holding portion 47 for holding the second nut 36. The first bolt 34 held in the first holding portion 46 extends, for example, along the depth direction Z from the first holding portion 46. That is, the first bolt 34 is so held in the first holding portion 46 that the axis L1 thereof extends along the depth direction Z. The second nut 36 is so held in the second holding portion 47 that the axis L2 thereof extends along the depth direction Z.

The first and second holding portions 46, 47 are provided at positions shifted from each other in the depth direction Z of the terminal block 10. If the fastening direction D of the terminals to the first and second connecting portions 31, 32 is a forward direction, the second holding portion 47 is located in front of the first holding portion 46. In this way, the second connecting portion 32 held in the second holding portion 47 is located in front of the first connecting portion 31 held in the first holding portion 46.

The frame body 41 includes a first extending portion 48 extending downward. The first extending portion 48 forms a part of a second path restricting portion R2 to be described later. The first extending portion 48 extends, for example, obliquely from a lower part of the frame body 41.

### (Separate Component 50)

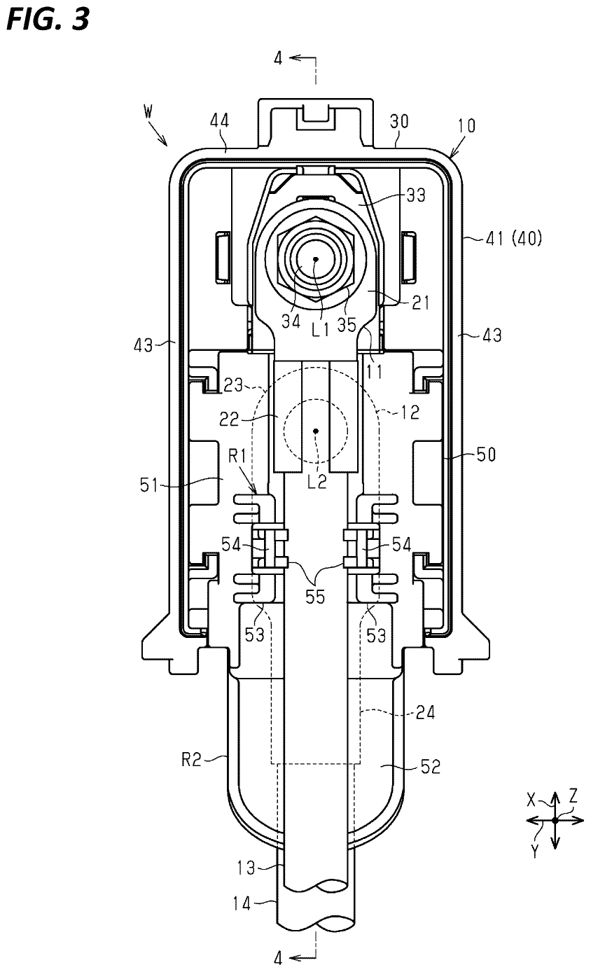

As shown in FIGS. 1 and 3, the separate component 50 is detachably mounted into the frame body 41 of the housing body 40. The separate component 50 includes a body portion 51 to be arranged inside the frame body 41 and a second extending portion 52 extending from the body portion 51. The body portion 51 is arranged between the pair of side walls 43 of the frame body 41.

The body portion 51 of the separate component 50 includes a first path restricting portion R1 for restricting a path of the first wire 13.

The first path restricting portion R1 includes a pair of wall portions 53. The pair of wall portions 53 are, for example, facing each other in the width direction Y of the terminal block 10. The first wire 13 is passed along the height direction X between the pair of wall portions 53. Each wall portion 53 is in contact with the first wire 13 or facing the first wire 13 across a tiny gap. In this way, the path of the first wire 13 is restricted by the pair of wall portions 53.

Each of the pair of wall portions 53 includes a resilient piece 54. Each resilient piece 54 is, for example, formed in a central part of each wall portion 53 in the height direction X. Each resilient piece 54 can be deflected to displace in the width direction Y. The respective resilient pieces 54 include projecting portions 55 projecting in directions toward each other from the respective resilient pieces 54.

The first wire 13 is mounted into the first path restricting portion R1 along the depth direction Z. At this time, the respective resilient pieces 54 are displaced in directions away from each other by contacting the first wire 13. Thereafter, if the first wire 13 is pushed to a proper position, the respective resilient pieces 54 resiliently return. An interval between the projecting portions 55 of the respective resilient pieces 54 is set to be smaller than a diameter of the first wire 13. In this way, with the first wire 13 mounted in the first path restricting portion R1, the first wire 13 is suppressed from coming out in the depth direction Z from the first path restricting portion R1 by the projecting portions 55 of the respective resilient pieces 54.

The second extending portion 52 of the separate component 50 forms a part of the second path restricting portion R2 for restricting a path of the second wire 14. The second extending portion 52 forms the tubular second path restricting portion R2 by being combined with the first extending portion 48 of the housing body 40. The second wire 14 is led out to the outside of the housing 30 through the second path restricting portion R2.

As shown in FIG. 4, in the housing 30, a first arrangement portion P1 where the first terminal 11 is arranged and a second arrangement portion P2 where the second terminal 12 is arranged overlap when viewed from the fastening direction D of the first and second connecting portions 31, 32, i.e. from the depth direction Z. Thus, the first terminal 11 arranged in the first arrangement portion P1 and the second terminal 12 arranged in the second arrangement portion P2 overlap when viewed from the fastening direction D (see also FIG. 3). In particular, the wire connecting portion 22 of the first terminal 11 and the fastening portion 23 of the second terminal 12 overlap when viewed from the fastening direction D. Further, the body portion 51 of the separate component 50 is located between the first and second arrangement portions P1, P2 in the fastening direction D. That is, the separate component 50 is located between the first and second terminals 11, 12 in the fastening direction D.

Next, an assembly mode of the wiring harness W is described.

First, the second terminal 12 connected to the second wire 14 is fastened and fixed together with the busbar 33 by the second nut 36 and the second bolt 37. At this time, the second bolt 37 is mounted to the second nut 36 in the fastening direction D.

Subsequently, the separate component 50 is mounted into the housing body 40. In this way, the second terminal 12 and the second wire 14 are partially covered by the body portion 51 of the separate component 50. By mounting the separate component 50 into the housing body 40, the second path restricting portion R2 is formed by the first extending portion 48 of the housing body 40 and the second extending portion 52 of the separate component 50. The second wire 14 is arranged inside the second path restricting portion R2.

Subsequently, the first terminal 11 connected to the first wire 13 is fastened and fixed together with the busbar 33 by the first bolt 34 and the first nut 35. At this time, the first nut 35 is mounted to the first bolt 34 in the fastening direction D. Further, at this time, the first wire 13 is mounted into the first path restricting portion R1 from the depth direction Z.

Functions of this embodiment are described.

The path of the first wire 13 is restricted by the first path restricting portion R1 of the housing 30. Further, the path of the second wire 14 is restricted by the second path restricting portion R2 of the housing 30. Therefore, the vibration of the first and second wires 13, 14 can be suppressed by the first and second path restricting portions R1, R2.

The first and second connecting portions 31, 32 are so configured that the fastening directions D thereof are the same direction. In this way, workability in mounting the first and second wires 11, 12 to the first and second connecting portions 31, 32 is improved.

By arranging the second connecting portion 32 in front of the first connecting portion 31 in the fastening direction D, the first arrangement portion P1 where the first terminal 11 is arranged and the second arrangement portion P2 where the second terminal 12 is arranged can be configured to overlap. As a result, the terminal block 10 can be reduced in size in the width direction Y orthogonal to the fastening direction D. In this way, the terminal block 10 can be arranged while a clearance between the terminal block 10 and a peripheral device such as the engine unit is ensured, for example, even if a mounting space of the terminal block 10 is limited to a small space in the engine compartment.

Effects of this embodiment are described.

(1) The housing 30 includes the first path restricting portion R1 for restricting the path of the first wire 13 and the second path restricting portion R2 for restricting the path of the second wire 14. According to this configuration, the first and second wires 13, 14 can be stably held by the first and second path restricting portions R1, R2 of the housing 30. As a result, the vibration of the first and second wires 13, 14 can be suppressed.

(2) The first and second terminals 11, 12 are respectively fastened and fixed to the first and second connecting portions 31, 32 of the terminal block 10. The first and second connecting portions 31, 32 are so configured that the fastening directions D thereof are the same direction. According to this configuration, the first and second terminals 11, 12 can be fastened and fixed to the respective first and second connecting portions 31, 32 from the same direction. Thus, workability in mounting the first and second terminals 11, 12 to the first and second connecting portions 31, 32 can be improved.

(3) The housing 30 includes the first arrangement portion P1 where the first terminal 11 is arranged and the second arrangement portion P2 where the second terminal 12 is arranged. The first and second arrangement portions P1, P2 overlap when viewed from the fastening direction D. Thus, the terminal block 10 can be reduced in size in the width direction Y orthogonal to the fastening direction D.

(4) The first and second connecting portions 31, 32 are provided at the positions shifted from each other in the fastening direction D. If the fastening direction D of the terminals to the connecting portions is the forward direction, the second connecting portion 32 is located in front of the first connecting portion 31. According to this configuration, by arranging the second connecting portion 32 in front of the first connecting portion 31 in the fastening direction D, the first arrangement portion P1 where the first terminal 11 is arranged and the second arrangement portion P2 where the second terminal 12 is arranged can be configured to overlap. As a result, it can contribute to the size reduction of the terminal block 10 in the direction orthogonal to the fastening direction D.

(5) The housing 30 includes the housing body 40 for holding the first and second connecting portions 31, 32 and the separate component 50 to be assembled with the housing body 40. The separate component 50 is located between the first and second arrangement portions P1, P2 in the fastening direction D. According to this configuration, the interference of the first and second wires 13, 14 respectively connected to the first and second terminals 11, 12 can be suppressed by the separate component 50 arranged between the first and second arrangement portions P1, P2.

(6) The entire first path restricting portion R1 and a part of the second path restricting portion R2 are provided in the separate component 50. According to this configuration, by providing the first and second path restricting portions R1, R2 in the separate component 50, the paths of the first and second wires 13, 14 can be respectively suitably restricted by the first and second path restricting portions R1, R2.

(7) The first connecting portion 31 includes the first bolt 34 held in the housing 30 and the first nut 35 to be mounted to the first bolt 34. The first terminal 11 is fastened by the first bolt 34 and the first nut 35. The second connecting portion 32 includes the second nut 36 held in the housing 30 and the second bolt 37 to be mounted to the second nut 36. The second terminal 12 is fastened by the second nut 36 and the second bolt 37. According to this configuration, at the time of mounting the first terminal 11, the first terminal 11 can be temporarily held by hooking the through hole 21a of the first terminal 11 to the first bolt 34 held in the housing 30. In this way, the mounting workability of the first terminal 11 can be improved.

Further, if the second connecting portion 32 is so configured that a bolt is held in the housing 30, similarly to the first connecting portion 31, this bolt projecting from the housing 30 may interfere with the first wire 13 and the first terminal 11. In that respect, not a bolt, but the second nut 36 is held in the housing 30 in the second connecting portion 32 of this embodiment. Thus, the second connecting portion 32 can be prevented from interfering with the first wire 13 and the first terminal 11.

(8) The first and second wires 13, 14 are pulled out in the height direction X of the terminal block 10. The first and second connecting portions 31, 32 are arranged along the height direction X when viewed from the fastening direction D. According to this configuration, the terminal block 10 can be reduced in size in the width direction Y orthogonal to the height direction X.

### Modifications

This embodiment can be modified and carried out as follows. This embodiment and the following modifications can be combined with each other and carried out without technically contradicting.
Similarly to the first connecting portion 31, the second connecting portion 32 may be so configured that the second bolt 37 is held in the second holding portion 47.
The first and second connecting portions 31, 32 may be, for example, arranged along the height direction X or the width direction Y.
The first and second arrangement portions P1, P2 may be configured not to overlap when viewed from the fastening direction D.
The fastening directions of the respective first and second connecting portions 31, 32 may be opposite to each other. Further, the fastening directions of the respective first and second connecting portions 31, 32 may not be in parallel.
The configuration such as the shape of the first path restricting portion R1 is not limited to that of the above embodiment and can be changed as appropriate according to the configuration of the terminal block 10. For example, the first path restricting portion R1 may be provided in the frame body 41 of the housing body 40.
The second path restricting portion R2 may be entirely provided in the separate component 50 or the housing body 40.
The housing 30 may not be provided with the separate component 50.
In the terminal block 10, the number of the connecting portions to be connected to the terminals is not limited to that in the above embodiment and may be three or more. According to that, the number of pairs of the wire and the terminal provided in the wiring harness may be three or more.
Although the first and second terminals 11, 12 are respectively crimped to the first and second wires 13, 14 in the above embodiment, there is no limitation to this. For example, the first and second terminals 11, 12 may be respectively connected to the first and second wires 13, 14 by another means such as welding.
The terminal block 10 may be provided in a location other than the engine compartment in the vehicle.
As shown in FIG. 2, the busbar 33 may be a bent plate including a first flat plate portion including the first through hole 33a, a second flat plate portion including the second through hole 33b and an intermediate plate portion connecting the first and second flat plate portions with a step in the depth direction Z formed therebetween. The first and second flat plate portions may be parallel to each other and may not be on the same plane. The intermediate plate portion may be orthogonal to each of the first and second flat plate portions. As shown in FIG. 2, the fastening portion 21 of the first terminal 11 may be a flat plate to be overlapped in parallel to the first flat plate portion of the busbar 33. The fastening portion 23 of the second terminal 12 may be a flat plate to be overlapped in parallel to the second flat plate portion of the busbar 33. As shown in FIG. 3, when the first and second terminals 11, 12 are fastened to the busbar 33, the through holes 21a, 23a, 33a and 33b of the first terminal 11, the second terminal 12 and the busbar 33 may be, for example, aligned in a row in the height direction X. As shown in FIGS. 3 and 4, the first and second path restricting portions R1, R2 may be directly in contact with parts of the first and second wires 13, 14 so that the first and second wires 13, 14 are oriented and pulled out on a common plane, which is an XZ plane, and in mutually different directions (e.g. directly downward and obliquely downward to the right in FIG. 4). This configuration is advantageous in reducing swing amplitudes of the wires 13, 14 and advantageous in thinning the terminal block 10, in which a plurality of terminals are densely provided, in the width direction Y.
The embodiment and the modifications disclosed this time are illustrative in all aspects and the present invention is not limited to these illustrations. That is, the scope of the present invention is represented by claims and intended to include all changes in the scope of claims and in the meaning and scope of equivalents.

List of Reference Numerals

| | |
|---|---|
| 10 | terminal block |
| 11 | first terminal (terminal) |
| 12 | second terminal (terminal) |
| 13 | first wire (wire) |
| 14 | second wire (wire) |
| 21, 23 | fastening portion |
| 21a, 23a | through hole |
| 22, 24 | wire connecting portion |
| 30 | housing |
| 31 | first connecting portion (connecting portion) |
| 32 | second connecting portion (connecting portion) |
| 33 | busbar |
| 33a | first through hole |
| 33b | second through hole |
| 34 | first bolt |
| 35 | first nut |
| 36 | second nut |
| 37 | second bolt |
| 40 | housing body |
| 41 | frame body |
| 42 | holding component |
| 43 | side wall |
| 44 | upper wall |
| 45 | mounting portion |
| 46 | first holding portion |
| 47 | second holding portion |
| 48 | first extending portion |
| 50 | separate component |
| 51 | body portion |
| 52 | second extending portion |
| 53 | wall portion |
| 54 | resilient piece |
| 55 | projecting portion |
| D | fastening direction (fixing direction) |
| L1, L2 | axis |
| P1 | first arrangement portion |
| P2 | second arrangement portion |
| R1 | first path restricting portion (path restricting portion) |
| R2 | second path restricting portion (path restricting portion) |
| W | wiring harness |
| X | height direction |
| Y | width direction |
| Z | depth direction |

1. A terminal block, comprising:
a plurality of connecting portions to be respectively connected to a plurality of terminals of a plurality of wires;
a busbar for electrically connecting the plurality of connecting portions; and
a housing for accommodating the plurality of connecting portions and the busbar,
the housing including a path restricting portion for restricting a path of at least one of the plurality of wires.

2. The terminal block of claim 1, wherein:
the plurality of terminals are respectively fastened and fixed to the plurality of connecting portions, and
the plurality of connecting portions are so configured that fixing directions of the plurality of terminals to the plurality of connecting portions are the same direction.

3. The terminal block of claim 2, wherein:
the plurality of terminals include a first terminal and a second terminal,
the housing includes a first arrangement portion where the first terminal is arranged and a second arrangement portion where the second terminal is arranged, and
the first and second arrangement portions at least partially overlap in the fixing direction.

4. The terminal block of claim 3, wherein:
the plurality of connecting portions include a first connecting portion to be connected to the first terminal and a second connecting portion to be connected to the second terminal,
the first and second connecting portions are provided at positions shifted from each other in the fixing direction, and
the second connecting portion is located in front of the first connecting portion if the fixing direction of the terminals to the connecting portions is a forward direction.

5. The terminal block of claim 4, wherein:
the housing includes a housing body for holding the first and second connecting portions and a separate component to be assembled with the housing body,
the separate component is located between the first and second arrangement portions in the fixing direction, and
the path restricting portion is at least partially provided in the separate component.

6. The terminal block of claim 5, wherein:
the plurality of wires include a first wire provided with the first terminal and a second wire provided with the second terminal,
the path restricting portions include a first path restricting portion for restricting a path of the first wire and a second path restricting portion for restricting a path of the second wire, and
the first and second path restricting portions are at least partially provided in the separate component.

7. The terminal block of claim 4, wherein:
the first connecting portion includes a first bolt held in the housing and a first nut to be mounted to the first bolt,
the first terminal is fastened by the first bolt and the first nut,
the second connecting portion includes a second nut held in the housing and a second bolt to be mounted to the second nut, and
the second terminal is fastened by the second nut and the second bolt.

8. The terminal block of claim 4, wherein:
the plurality of wires are pulled out in a height direction of the terminal block when viewed from the fixing direction, and
the first and second connecting portions are provided at positions shifted from each other in the height direction.

9. A wiring harness, comprising:
the terminal block of claim 1;
a plurality of terminals to be mounted into the terminal block; and
a plurality of wires respectively provided with the plurality of terminals.
